(19) United States
(12) Patent Application Publication
(10) Pub. No.: US 2006/0046895 A1
(43) Pub. Date: Mar. 2, 2006

(54) Vehicular control system for regenerative braking

(76) Inventors: Russell James Thacher, Monroe, NC (US); James William Musser, Charlotte, NC (US)

Correspondence Address: DEERE & COMPANY, ONE JOHN DEERE PLACE, MOLINE, IL, 61265, US

(21) Appl. No.: 10/929,655

(22) Filed: Aug. 30, 2004

(51) Int. Cl. B60K 41/02

(52) U.S. Cl. 477/4

(57) ABSTRACT

A system and method for controlling a vehicle for regenerative braking facilitates decreasing the warm-up time of the fuel cell stack from start-up to full electrical power generation capacity. A controller detects a starting time of a fuel cell stack associated with a vehicle. A drive motor generates electrical energy during braking or deceleration of the vehicle, where the drive motor is mechanically coupled to at least one wheel of the vehicle. A controller refers to or determines a time window following the starting time. The switching unit routes the electrical energy to a resistive load associated with a heat exchanger thermally coupled to a fuel cell stack of the vehicle if the electrical energy is generated during the time window.

### FIELD OF THE INVENTION

This invention relates to a vehicular control system for regenerative braking.

### BACKGROUND OF THE INVENTION

A regenerative braking unit may comprise a traction motor that is used to slow or to stop a vehicle. For example, the regenerative braking unit may act as a generator that converts mechanical energy of wheel rotation into electrical energy. In the prior art, locomotives or other diesel-electric hybrid vehicles may dissipate such generated electrical energy as wasted thermal energy in resistors. For fuel-cell powered vehicles, from time to time the electrical energy generated by regenerative braking may exceed the available storage capacity of the vehicular batteries; adding additional batteries may appreciably increase the price and weight of the vehicle. Therefore, there is need to enhance the energy management of electrically-driven fuel cell vehicles that are equipped with regenerative braking.

### SUMMARY OF THE INVENTION

In accordance with one aspect of the invention, a system and method for controlling a vehicle for regenerative braking facilitates decreasing the warm-up time of the fuel cell stack from start-up (e.g., cold start-up) to full electrical power generation capacity. A controller detects a starting time of a fuel cell stack associated with a vehicle. A controller refers to or determines a time window following the starting time, where the time window is based on at least one of the following factors: (1) lapse of a minimum threshold period of time from the starting time, (2) an ambient temperature around the vehicle or fuel cell, (3) temperature of the fuel cell stack reaches a desired operational temperature or range, and (4) whether the start of the fuel cell occurred as a cold start or a warm start. A drive motor generates electrical energy during braking or deceleration of the vehicle, where the drive motor is mechanically coupled to at least one wheel of the vehicle. A switching unit routes the electrical energy to a resistive load associated with a heat exchanger thermally coupled to a fuel cell stack of the vehicle if the electrical energy is generated during the time window.

### BRIEF DESCRIPTION OF THE DRAWINGS

FIG. 1 is a block diagram of a system for controlling a vehicle having regenerative braking in accordance with this invention.

FIG. 2 is one embodiment of a method for controlling a vehicle having regenerative braking.

FIG. 3 is another embodiment of a method for controlling a vehicle having regenerative braking.

FIG. 4 is yet another embodiment of a method for controlling a vehicle having regenerative braking.

FIG. 5 is still another embodiment of a method for controlling a vehicle having regenerative braking.

FIG. 6 is a block diagram of the fuel cell assembly (including the fuel cell stack) in greater detail than FIG. 1.

FIG. 7 is an alternate embodiment of a system for controlling a vehicle having regenerative braking in accordance with this invention.

FIG. 8 is another alternate embodiment of a system for controlling a vehicle having regenerative braking in accordance with this invention.

### DESCRIPTION OF THE PREFERRED EMBODIMENTS

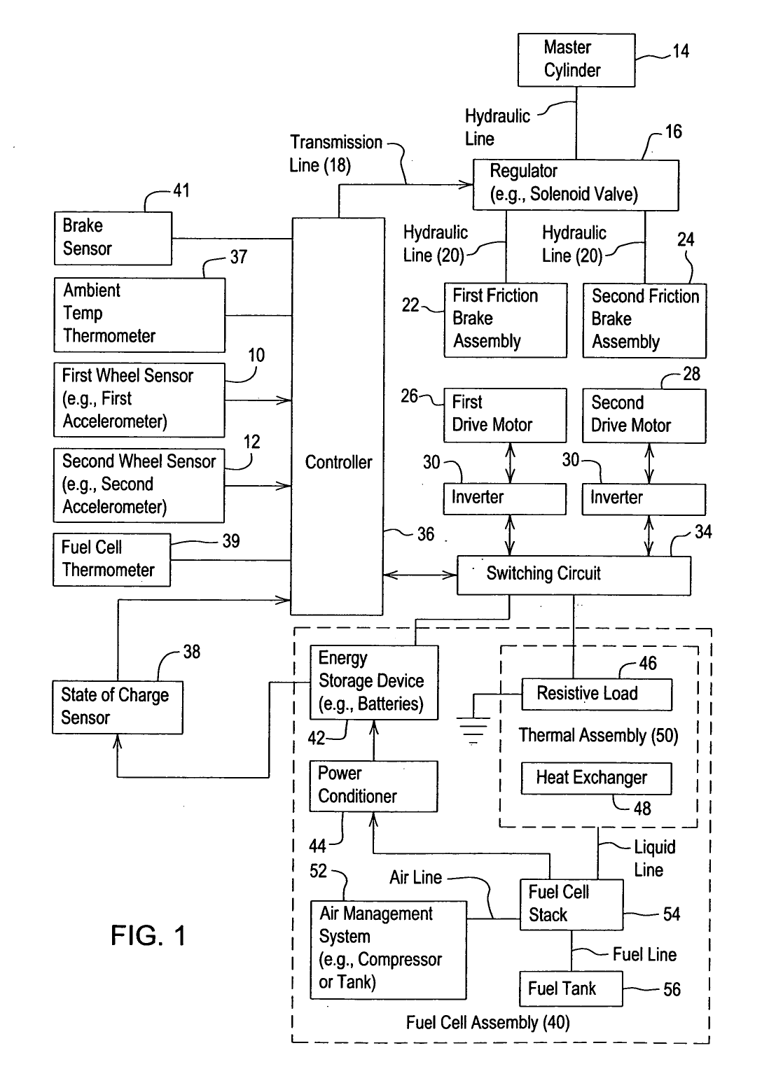

In FIG. 1 in accordance with one embodiment, a system for controlling a vehicle or managing electrical energy associated with a vehicle comprises a first drive motor 26 and a second drive motor 28. The first drive motor 26, the second drive motor 28, or both are coupled to wheels of the vehicle to propel the vehicle in a propulsion mode or to decelerate the vehicle in a regenerative braking mode. Regenerative braking refers to using the first drive motor 26, the second drive motor 28, or both to oppose the motion of the vehicle. During the regenerative braking mode, one or more of the drive motors (26, 28) convert the kinetic energy of the moving vehicle into electrical energy; the fuel cell assembly 40 may provide a load or energy storage device 42 to accept electrical energy generated by one or more drive motors (26, 28).

In contrast, during the propulsion mode, the energy storage device 42, the fuel cell stack 54, or the fuel cell assembly 40 provides electrical power to one or more drive motors (26, 28). If the drive motors (26, 28) are drive motors that operate on alternating current, each drive motor is associated with a corresponding inverter 30 for converting direct current (DC) electricity into alternating current (AC) electricity. If the drive motors operate on direct current (DC), the inverters 30 may be eliminated.

A switching circuit 34 manages the flow of electrical energy between the drive motors (26, 28) and the fuel cell assembly 40. For instance, the switching circuit 34 manages the flow of electrical energy between the driver motors (26,28), and any of the following components: (a) the energy storage device 42 (e.g., batteries), (b) the resistive load 46, and (c) the fuel cell stack 54. The switching circuit 34 may have one or more states consistent with the regenerative braking mode and one or more states consistent with the propulsion mode. The operator of a vehicle or a navigation control system may cause the transition to occur between the regenerative braking mode and the propulsion mode, subject to the supervision of the controller 36.

A controller 36 is arranged to communicate with the switching circuit 34, a state-of-charge sensor 38, an ambient temperature thermometer 37, a fuel cell thermometer 39, a first wheel sensor 10 (e.g., first accelerometer), a second wheel sensor 12 (e.g., second accelerometer), and a brake sensor 41. The state-of-charge sensor 38, the ambient temperature thermometer 37, the fuel cell temperature thermometer 39, the first wheel sensor 10, and the second wheel sensor 12, the brake sensor 41 are arranged to provide input data to the controller 36. The controller 36 processes the input data and provides control data or a control signal to the switching circuit 34, the regulator 16, or both based on software, instructions, rules or logic devices associated with the controller 36.

The fuel cell assembly 40 comprises a fuel cell stack 54 that is associated with a fuel tank 56 and an air management system 52. The fuel tank 56 stores fuel (e.g., hydrogen or another combustible gaseous fuel) for the fuel cell stack 54. The air management system 52 may comprise one or more of the following: (1) an air compressor, (2) a source of oxygen, (3) a source of air, (4) compressed air stored in a tank, (5) compressed oxygen stored in a tank, and (6) a pressure regulator to regulate the pressure and flow of air to the fuel cell stack 54. The fuel tank 56 may be coupled to the fuel cell stack 54 via a fuel line. The fuel cell stack 54 accepts the inputted fuel and air (or oxygen) and creates electricity and waste water therefrom.

As illustrated in FIG. 1, the fuel cell assembly 40 further comprises a power conditioner 44, a thermal assembly 50, and an energy storage device 42. In one embodiment, the fuel cell stack 54 is coupled to the energy storage device 42 via the power conditioner 44. The power conditioner 44 may provide filtering of the electrical output of the fuel cell stack 54 to make it more suitable for charging a battery or assembly of batteries as the energy storage device 42. For example, the power conditioner 44 may include a voltage regulator, a current regulator, a limiter, noise filtering or reduction, overload protection, capacitive filtering, or any combination of the foregoing items. Further, the power conditioner 44 may facilitate load matching (e.g., an impedance match) between an electrical output of the fuel cell stack 54 and the electrical input of the energy storage device 42.

The thermal assembly 50 comprises at least a resistive load 46 and a heat exchanger 48 (e.g., radiator). In one embodiment, the resistive load 46 comprises several high-power dissipation resistors arranged in a parallel network. Such resistors are rated in power commensurate with the electrical power generated by the first drive motor 26 and the second drive motor 28 during sustained regenerative braking from a maximum speed or velocity of the vehicle.

The fuel cell stack 54 may be associated with a heat exchanger 48 to dissipate heat generated from operation of the fuel cell stack 54. The heat exchanger 48 may be coupled to the fuel cell stack 54 via one or more of the following: an intake line, an exhaust line, a liquid-carrying line, a radiator hose, hose, tubing, conduit, or the like. The resistive load 46 may be in thermal communication with the heat exchanger 48, the intake line, the exhaust line, or any other liquid-carrying line.

The fuel cell assembly 40 has a coolant loop for managing the heat dissipation of the fuel cell stack 54. The coolant loop comprises the combination of an intake line, the heat exchanger 48 (e.g., radiator), and an exhaust line. The coolant loop may be connected to a coolant intake manifold (at a fuel cell cooling entrance) and a coolant exhaust manifold (at a fuel cell cooling exit) of the fuel cell stack 54. A pump for pumping the coolant may circulate the coolant (e.g., water or water solution with anti-freeze chemicals) within the coolant loop between the heat exchanger 48 and the fuel cell stack 54, as well as within the fuel cell stack 54. In a typical fuel cell stack 54, one or more cooling channels are located between each cell, which are electrically connected in series with each other. The cooling channels are associated with a coolant intake manifold and a coolant exhaust manifold of the fuel cell stack 54.

In one embodiment, a braking system comprises a master cylinder 14, a regulator 16 (e.g., solenoid valve), a first friction brake assembly 22 and a second friction brake assembly 24. The master cylinder 14 is coupled to the regulator 16 via a hydraulic line. In turn, the regulator 16 (e.g., solenoid valve) is coupled to a first friction brake assembly 22 and a second friction brake assembly 24 via hydraulic lines 20. Each friction brake assembly (22, or 24) may comprise a drum brake assembly, a disc brake assembly, or the like that is associated with a corresponding wheel. The regulator 16 may regulate the flow of hydraulic fluid to one more friction brake assemblies, including a first friction brake assembly 22 and a second friction brake assembly 24 to provide control over deceleration and stopping of the vehicle.

A brake sensor 41 may be associated with a master cylinder 14, a brake pedal, a brake light circuit, or a friction brake assembly to provide an input signal or input data to the controller 36. The brake sensor 41 may indicate when an operator or unmanned vehicular navigation system applies the brakes via the master cylinder 14. The controller 36 may decide when to switch from the propulsion mode to the regenerative braking mode based on input from the brake sensor 41. The controller 36 provides an electrical signal to control the regulator 16 via transmission line 18 (e.g., a wire, cable, optical fiber). The controller 36 may increase the flow of hydraulic fluid between the master cylinder 14 and a friction brake assembly (22 or 24) to supplement the braking power provided by the first drive motor 26 and the second drive motor 28, for example. Further, if the drive motors (26, 28) fail to provide braking or to provide sufficient braking, the regulator 16 may permit the increased flow of fluid to the first friction brake assembly 22 and the second friction brake assembly 24.

The state-of-charge sensor 38 measures one or more parameters (e.g., open-circuit voltage of the battery, battery temperature, battery resistance) that may be used to estimate the state of charge of a battery. For example, the state of charge may be estimated primarily from an open-circuit voltage of the battery and may depend secondarily upon the internal resistance of the battery, temperature, and battery capacitance. The state of charge of a battery may be expressed as a percentage of the rated capacity of a battery (for a corresponding evaluation time).

The ambient temperature thermometer 37 measures the ambient temperature around the fuel cell stack 54 or the vehicle. The fuel cell thermometer 39 measures the temperature within the fuel cell stack 54 or associated with a thermal assembly 50 for cooling the fuel cell assembly 40. The temperature measured by the fuel cell thermometer 39 may be referred to as the “cell temperature,” the “stack temperature,” or the “fuel cell temperature,” as synonomous expressions. The controller 36 may use the measured ambient temperature, the stack temperature, or both to determine whether the fuel cell stack 54 has undergone a cold start or a warm start. A cold start means a fuel cell temperature is equal to or within a maximum range of the ambient temperature, whereas a warm start means that the fuel cell stack temperature is within a known operational temperature range of the fuel cell. The fuel cell stack 54 generates its full electrical capacity when it reaches or maintains its operational temperature. For example, after starting up the fuel cell, the oxidation, reduction or other chemical reactions that occur within the fuel cell stack 54 are increased in efficiency or rate by the increase in temperature of the fuel cell, at least up to the normal operational temperature.

During the regenerative braking mode, the controller 36 may determine to route the electrical energy from one or more drive motors (e.g., first drive motor 26) to a resistive load 46 of the fuel cell assembly 40, if the fuel cell assembly 40 is operating within a time window or if the fuel cell temperature is less than a threshold minimum temperature. The time window may be based on one or more of the following factors: (1) lapse of a minimum threshold period of time from the starting time, (2) an ambient temperature around the vehicle or fuel cell, (3) temperature of the fuel cell stack reaches a desired operational temperature or range, and (4) whether the start of the fuel cell occurred as a cold start or a warm start.

The fuel cell assembly 40 is associated with a resistive load 46 for facilitating thermal management of the fuel cell stack 54 during the time window (and after the time window). The controller 36 may direct the switching circuit 34 to connect the resistive load 46 (of certain resistors associated therewith) to an output potential of the drive motor (e.g., the first drive motor 26) or the a direct current bus of the vehicle. In one embodiment, the resistive load 46 is a separate module from the fuel cell stack 54 and is in thermal communication with a coolant loop of the fuel cell stack 54. The additional heat added to the coolant loop from the resistive load 46 may be dissipated in the heat exchanger (e.g., vehicle radiator) before the coolant returns to the fuel cell stack 54.

The resistive load 46 may be physically mounted in the vehicle coolant loop (a) between the fuel cell cooling exit and the entrance to the heat exchanger 48, (b) between the fuel cell cooling entrance and the exit of the heat exchanger 48, (c) between the fuel cell cooling exit and pump associated with the cooling system, and (d) between the fuel cell cooling entrance and a pump associated with the thermal assembly 48.

The resistive load 46 may be electrically connected or coupled to a direct current bus of the vehicle and in thermal communication with a fuel cell stack 54, a heat exchanger 48 (e.g., radiator) or a coolant loop of the vehicle. The heat exchanger 48 does not need to be sized any larger because when the vehicle is braking, the fuel cell stack 54 will not be under any material electrical load from propelling the vehicle and the heat exchanger 48 (e.g., radiator) is used to cool the resistive load 46, rather than the fuel cell stack 54 at that time.

A fuel-cell-powered vehicle may not have sufficient battery capacity to store energy generated by regenerative braking through electric drive motors (e.g., 26 and 28). Accordingly, the switching circuit 34 may route electrical energy generated through regenerative braking to one or more of the following recipient devices: (a) an energy storage device 42 (e.g., batteries or an ultracapacitor), (b) an ultracapacitor module, (c) a the resistive load 46, (d) various components of the resistive load 46, and (e) any combination of the foregoing devices. It is understood that the controller 36 may direct the switching circuit 34 to assigned time slots or time duration on an on-going or dynamic basis to the foregoing recipient devices.

In one configuration, the switching circuit 34 supports software, logic, or rules observed by the controller 36 for individually switching (e.g., according to PWM) one or more resistors of the resistive load 46 on or off a bus (e.g., direct current bus of the vehicle) to dynamically change the value of the resistive load in real time. The switching circuit 34 should have sufficiently high switching speed to permit advance control and switching of resistors or resistive components of the resistive load 46. In another configuration, the switching circuit 34 may be controlled by pulse width modulation (PWM) control signals from the controller 36. The resistors may be instantaneously switched onto and off the direct current bus of the vehicle in a controlled manner for discrete controllable time periods or time slots. Accordingly, the PWM supports the stepless, infinitely variable, or continuously variable resistance values for the resistive load 46.

In one embodiment, the controller 36 may interface with a driver (not shown) associated with or integrated into the switching circuit 34. The driver accepts the input of digital logic signals as a control signal and generates a refined control signal (e.g., a pulse-width-modulated (PWM) signal) for controlling one or more switches (e.g., semiconductor switches or relays) of the switching circuit 34 in accordance with the propulsion mode, regenerative braking mode, or both.

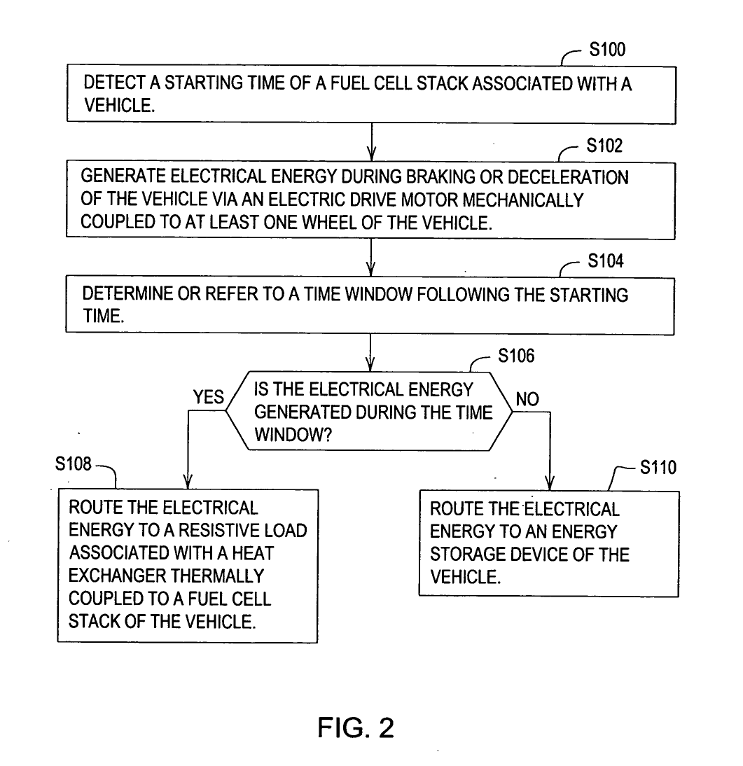

FIG. 2 shows a method for controlling a vehicle for having regenerative braking. For example, FIG. 2 may show a method for controlling an electrical system of a fuel cell powered vehicle having regenerative braking. The method of FIG. 2 starts in step S100.

In step S100, a controller 36 or a timer detects a starting time of a fuel cell stack 54 associated with a vehicle. For example, in one embodiment, if the vehicle ignition switch is turned on from an off state, the starting time is established contemporaneously therewith and a timer begins to run immediately thereafter.

In step S102, the first drive motor 26, the second drive motor 28, or both generate electrical energy during braking or deceleration of the vehicle with an electric drive motor (26 or 28) mechanically coupled to at least one wheel of the vehicle. The drive motors (26 or 28) act as alternators (for AC motors) or generators (for DC motors) to generate electrical energy. The alternator may generate electrical energy in alternating current form which can be rectified by a rectifier (e.g., a bridge diode array), whereas the generator may generate electrical energy in direct current form. The vehicular momentum and motion turns the wheels of the vehicle, which in turn rotates the shaft of the drive motor (26 or 28) (via one or more drive train components gears, joints, universal joints, differential, gear boxes, shafts, or another mechanical linkage for rotational energy) to produce electrical energy.

In step S104, the controller 36 or timer determines or refers to a time window (or compliance metric which can be expressed as the time window or time interval) following the starting time. The procedure of step S104 may be carried out in accordance with several techniques, that may be applied alternately or cumulatively with respect to each other. Under a first technique, the time window is based on the lapse of a certain minimum time period after the starting time. Under a second technique, the time window is based on the lapse of a certain minimum time period after the starting time, where the minimum time period is selected based on the power capacity, type (e.g., polymer electrolyte membrane or solid oxide fuel cell), geometry, or configuration of the fuel cell stack 54.

Under a third technique, the time window is based on the lapse of a certain minimum time period after the starting time and the time window is adjusted (e.g., once or on an ongoing or dynamic basis) based on one or more readings of the fuel cell thermometer 39, the ambient temperature thermometer 37, or both. In one example, the time window may be established as a lesser time (e.g., approximately 20 seconds) where the ambient temperature is at room temperature (e.g., 22 degrees Celsius) and a greater time where the ambient temperature is substantially below room temperature (e.g., 0 degrees Celsius). In another example, if the fuel cell was recently shut-off when it reached full operating temperature, the time window may be shortened based on the then-existing fuel cell stack temperature that is above ambient temperature.

Under a fourth technique, the time window is equal to or based on the corresponding duration for fuel cell temperature to meet or exceed a minimum threshold temperature (e.g., sensed via the fuel cell thermometer 39). For example, for a PEM fuel cell, the minimum threshold temperature may be approximately 65 degrees Celsius.

Under a fifth technique, the time window is based on whether the vehicle is started as a warm start or a cold start. If the vehicle stack temperature is within a certain maximum range of its operational temperature (e.g., plus or minus 15 degrees of an operational temperature of 65 degrees Celsius or plus or minus 15 degrees of an operational temperature of 80 degrees Celsius), the controller 36 may regard the start at a warm start; otherwise, the start may be regarded as a cold start. The controller 36 may assign a respective cold-start time window for a cold start, that is greater than the respective warm-start time window for a warm start.

Under a sixth technique, the controller may access a look-up table, reference database, or reference data to determine a corresponding time window for a measured vehicle cell temperature provided by the fuel cell thermometer 39.

Under step S106, the controller 36 determines if the electrical energy is generated during the time window (e.g., adjusted time window or another such compliance metric) of step S104. If the electrical energy is generated during the time window, the method continues with step S108. However, if the electrical energy is not generated during the time window, the method continues with step S110.

In step S108, the controller 36 instructs the switching circuit 34 to route the generated electrical energy from one or more drive motors (e.g., 26 or 28) to a resistive load 46 consistent with the regenerative braking mode. In one example of executing the regenerative braking mode in step S108, the switching circuit 34 switches the potential generated by the drive motors (e.g., first drive motor 26, second drive motor 28, or both) to a resistive load 46 (e.g., one or more resistors associated therewith). For instance, the resistive load 46 may be connected between the potential generated by the first drive motor 26 and an electrical ground connection on the vehicle bus, either directly or via a resistive divider network, to dissipate the generated electrical energy as thermal energy. The resistive load 46 is placed in thermal communication with a heat exchanger 48, a coolant loop, a fuel cell stack 54, or any combination of the foregoing items. For example, the resistive load 46 may be placed in thermal communication with the heat exchanger 48, or a fluid-carrying line between the heat exchanger 48 and the fuel cell stack 54. The thermal energy from the resistive load 46 is transferred to heat the coolant loop. The coolant loop is cooled through the heat exchanger 48 (e.g., radiator) exchanging thermal energy across the temperature gradient between the coolant in the heat exchanger and the ambient temperature. In one configuration, the fuel cell stack 54, the generated electrical power from the regenerative braking, or both are loaded down with the resistive load 46 during a startup time window to increase the coolant temperature, which shortens the time duration between ignition and full electrical power generation capability of the fuel cell stack 54.

In step S110, the controller 36 instructs the switching circuit 34 to route the electrical energy into an energy storage device 42 of the vehicle if the electrical energy is generated after the time window. For example, the switching circuit 34 may route the electrical energy into batteries as the energy storage device 42.

In an alternate example of carrying out step S110 and particularly where the fourth technique of step S104 is applied, the controller 36 instructs the switching circuit 34 to route electrical energy to the resistive load 46 until the minimum threshold temperature of the fuel cell stack thermometer is reached; once the minimum threshold temperature is reached the switching reroutes the electrical energy from the resistive load 46 to another recipient device.

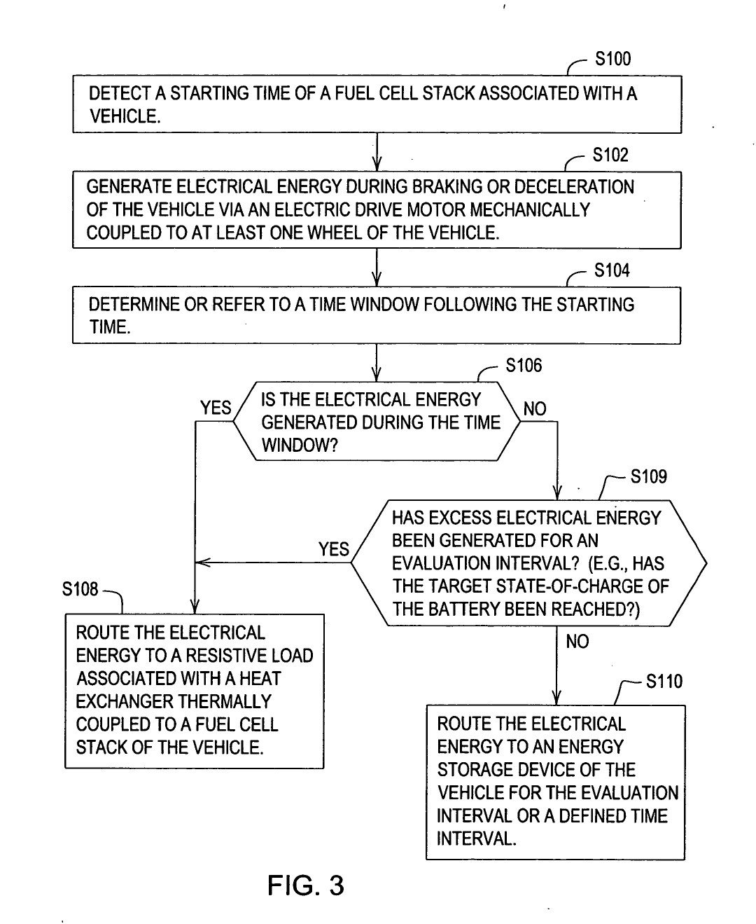

The method of FIG. 3 is similar to the method of FIG. 2, except that the method of FIG. 3 includes decision block or additional step S109, which may occur after step S106.

Under step S106, the controller 36 determines if the electrical energy is generated during the time window (e.g., adjusted time window or other such compliance metric) of step S104. If the electrical energy is generated during the time window, the method continues with step S108. However, if the electrical energy is not generated during the time window or in conformity with another such compliance metric, the method continues with step S109.

In step S109, the controller 36 determines if excess electrical energy has been generated by one or more drive motors (e.g., 26 or 28) for an evaluation interval during or immediately following regenerative braking. For example, excess electrical energy generated may be defined in accordance with any of the following definitions, which may be applied alternately and cumulatively.

Under a first definition, excess electrical energy has been generated if the target state of charge of the battery has been reached or exceeded for an evaluation interval. For instance, the target state of charge of the battery may range from approximately eighty-five to approximately ninety-five percent of rated battery capacity for an evaluation interval, or another target defined by user.

Under a second definition, excess electrical energy has been generated if the generated voltage from one or more drive motors (e.g., 26 or 28) exceeds a predetermined maximum threshold voltage for an evaluation interval during or immediately following regenerative braking.

Under a third definition, excess electrical energy has been generated if the current from one or more drive motors (e.g., 26 or 28) exceeds a predetermined maximum threshold current for an evaluation interval during or immediately following regenerative braking.

In step S109, if the controller 36 determines that excess electrical energy has been generated for the evaluation interval, then the method shall continue with step S108. However, the controller determines that excess electrical energy has not been generated for an evaluation interval, the method continues with step S110.

In step S108, the controller 36 instructs the switching circuit 34 to route electrical energy to a resistive load 46. The resistive load 46 is associated with a heat exchanger 48 thermally coupled to a fuel cell stack 54 of the vehicle. In one example, the excess voltage may be shunted to ground or switched to the resistive load 46 so as to maintain the maximum threshold voltage for a defined discharge interval. In another example, the excess current, if the detected current at a current sensor exceeds a predetermined maximum threshold voltage, the excess current is shunted to ground or switched to the resistive load 46 for a defined discharge interval so as to maintain the maximum threshold voltage.

In step S110, the controller 36 instructs the switching circuit 34 to route the electrical energy to an electrical storage device 42 (e.g., battery) for the evaluation interval or a defined time interval. The defined time interval may be greater than the evaluation interval, but not so great as to overcharge a battery or energy storage device 42 based on its state of charge, its rated capacity, and the applicable charging rate.

In an alternate example of carrying out step S110, the controller 36 may instruct the switching circuit 34 to fully charge the energy storage device 42 prior to routing energy to the dissipating resistive load 46 or another recipient device.

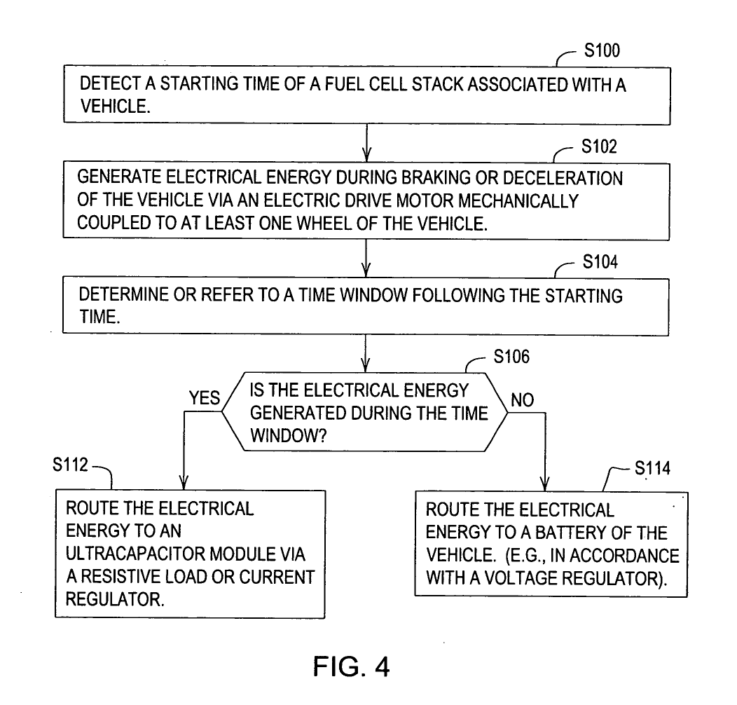

FIG. 4 is a flow chart of an alternate method for controlling regenerative braking of a vehicle. The method of FIG. 4 is similar to the method of FIG. 2, except the method of FIG. 4 replaces step S108 and S110, with step S112 and step S114, respectively. Like reference numbers in FIG. 2 and FIG. 4 indicate like steps or procedures.

In step S106, the controller 36 determines if electrical energy is generated during the time window. If the electrical energy is generated by regenerative braking during the time window, the method continues with step S112. However, if the electrical energy is not generated by regenerative braking during the time window, the method continues with step S114.

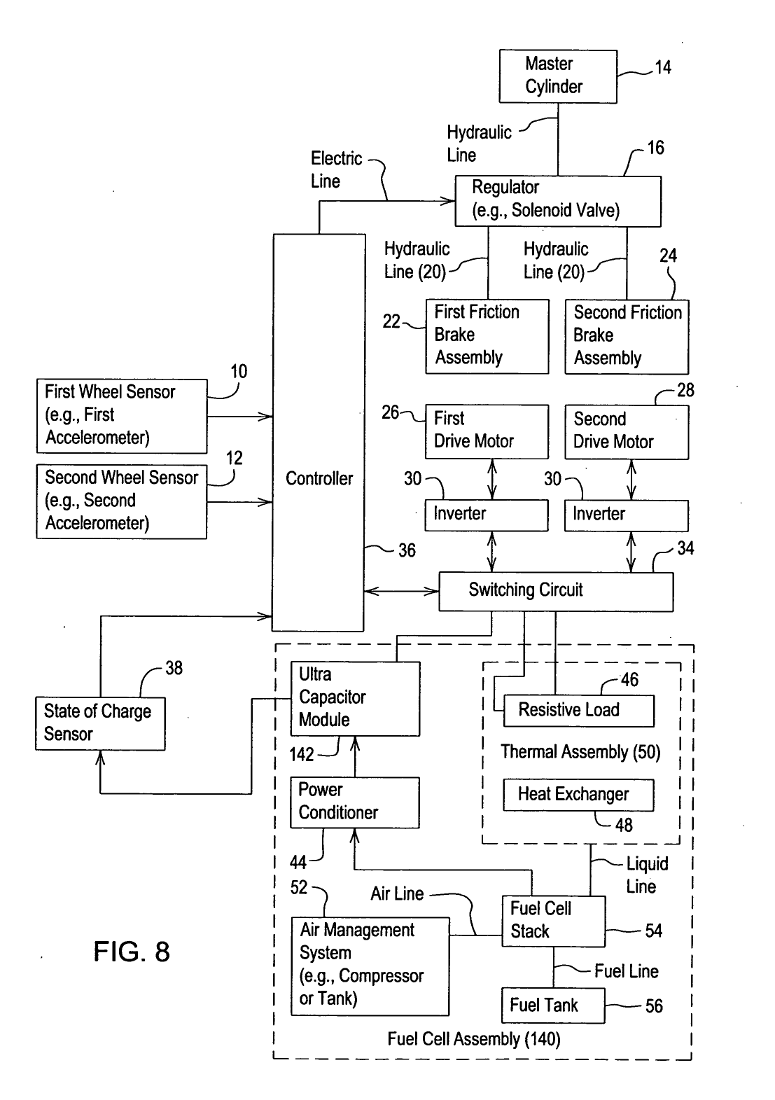

In step S112, the switching circuit 34 routes the electrical energy to an ultracapacitor (e.g., ultracapacitor module 142) of FIG. 8 via a resistive load 46. The resistive load 46 may be placed in series with the ultracapacitor (e.g., ultracapacitor module 142) to limit the charging current to the ultracapacitor. Accordingly, the switching circuit 34 and controller 36 facilitate a soft-start charging of the ultracapacitor (e.g., ultracapacitor module 142) during a start-up time window following ignition of the vehicle. Soft-start charging charges the ultracapacitor in a controlled manner to avoid damage to the ultracapacitor that might otherwise shorten its longevity and/or reduce its energy storage capacity.

In one embodiment of carrying out the soft-start mode, the vehicle bus may be disconnected from at least one electrical terminal of the fuel cell stack 54 to allow for charging of the ultracapacitor (e.g., ultracapacitor module 142) through the resistive load 46 or current regulator from power generated by one or more drive motors (e.g., 26 or 28) during regenerative braking (e.g., after propulsion or movement from electrical energy available from batteries on the vehicle). The resistive load 46 prevents the transient current (e.g., inrush current) from regenerative braking from improperly charging the ultracapacitor (e.g., ultracapacitor module 142), which may present an insufficiently low voltage (e.g., or impedance mismatch) to the fuel cell before the ultracapacitor module 142 is fully charged. The heat from the resistive load 46 during the soft start mode facilitates raising the fuel cell temperature quickly from ambient temperature to 65 Celsius operating temperature. In one embodiment, it takes approximately twenty seconds to fully charge the ultracapacitor module 142 such that the switching unit routes the electrical energy to an ultracapacitor module 142 via a resistive load 46 for approximately twenty seconds.

In step S114, the switching unit routes the electrical energy to a battery of the vehicle (e.g., in accordance with a voltage regulator). Step S114 may be executed in accordance with various alternate or cumulative techniques. Under a first technique, the switching unit routes the electrical energy to a battery of the vehicle if the state of charge measured by state of charge sensor 38 indicates that the battery is discharged or will accept an additional charge. Under a second technique, the switching unit routes the electrical energy to the battery to maintain a substantially full charge or a target state of charge. Under a third technique, the switching unit may alternate back and forth between the resistive load 46 and the battery to maintain a target state of charge (e.g., full charge) of the battery.

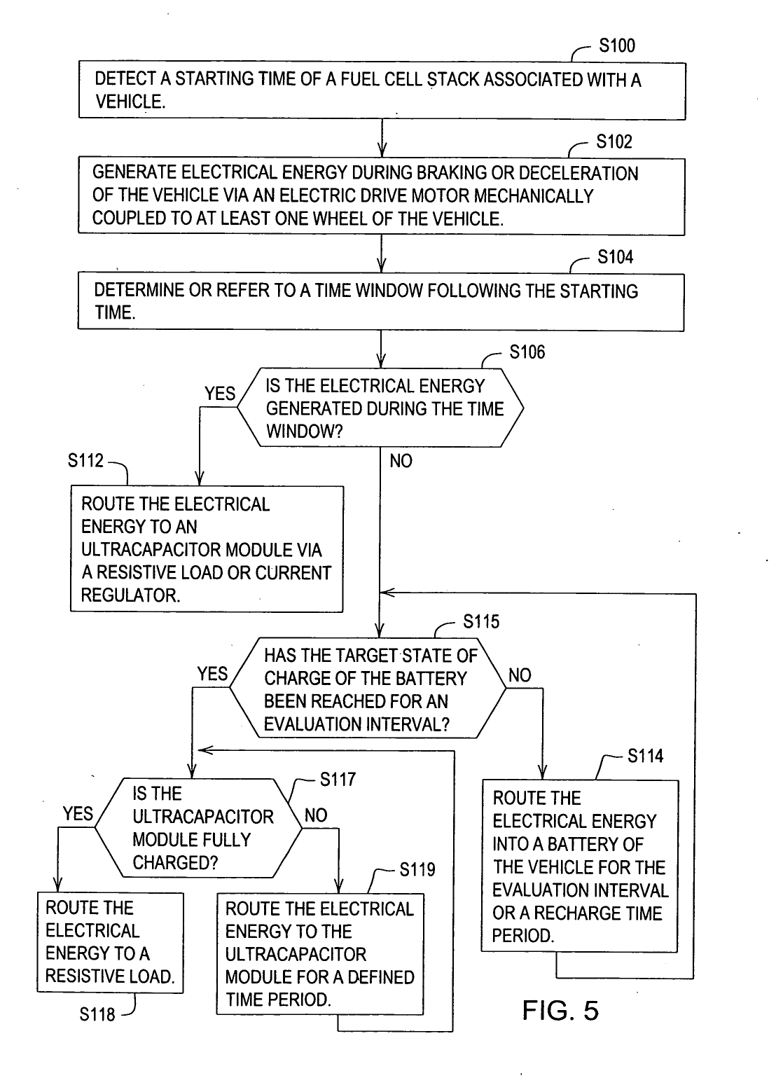

The method of FIG. 5 is similar to the method of FIG. 4, except the method of FIG. 5 includes additional steps S115, S117, S118, and S119. Like reference numbers in FIG. 4 and FIG. 5 indicate like steps or procedures.

In step S106, the controller 36 determines if electrical energy is generated by the regenerative braking during the time window. If electrical energy is generated during the time window, the method continues with step S112. However, if electrical energy is not generated by the regenerative braking during the time window, the method continues with step S115.

In step S112, the controller 36 directs the switching circuit 34 to route the electrical energy to an ultracapacitor via a resistive load 46 or a current regulator.

In step S115, a state of charge sensor 38, a controller 36, or both determine if the target state-of-charge of the battery has been reached. If the controller 36 or the state of charge sensor 38 determines that a target state of charge of the battery has been reached for an evaluation interval, the method may continue with step S117. However, if it is determined that the target state of charge of the battery has not been reached for the evaluation interval, the method continues with step S114.

In step S114, the controller 36 directs the switching circuit 34 to route the electrical energy to a battery of the vehicle for the evaluation period or a recharge time period.

In step S117, the controller 36 determines if the ultracapacitor (e.g., ultracapacitor module 142) is fully charged for an evaluation period. If the ultracapacitor module 142 is fully charged for the evaluation period, the method continues with step S118. However, if the ultracapacitor (e.g., ultracapacitor module 142) is not fully charged, then the method continues with step S119.

In step S118, the controller 36 directs the switching circuit 34 to route electrical energy to a resistive load 46. For example, the controller 36 may enable the switching circuit 34 to intermittently or continuously direct electrical energy to a resistive load 46 for a predetermined duration. The intermittent direction of electrical energy may be accomplished through PWM, for example.

In step S119, the controller 36 directs the switching circuit 34 to route electrical energy to the ultracapacitor (e.g., ultracapacitor module 142) for storage for a defined time period. For instance, the controller 36 may direct the switching circuit 34 to route electrical energy for a defined time period to maintain a certain minimum level of charge in the ultracapacitor.

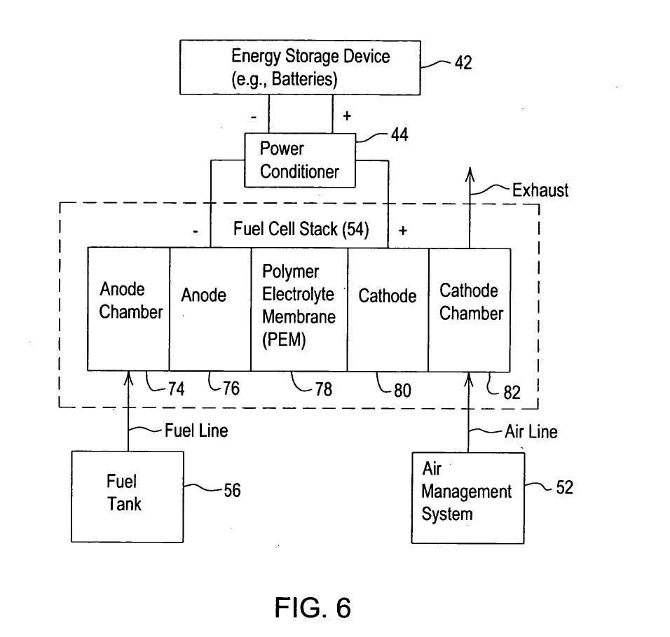

FIG. 6 is an illustrative embodiment of one possible configuration of the fuel cell assembly 40 of FIG. 1. The fuel cell assembly 40 comprises a fuel cell stack 54 comprising multiple cells that are electrically interconnected to provide a desired voltage output. As shown a representative polymer electrolyte membrane 78 (PEM) fuel cell of the fuel cell stack 54 is shown, although in alternate embodiments another type of fuel cell such as an solid oxide fuel cell, an alkaline fuel cell (AFC), or an alcohol fuel cell may be used. Each fuel cell within a fuel cell stack 54 comprises an anode 76, a cathode 80, a polymer electrolyte membrane 78, an anode chamber 74, and a cathode chamber 82. In one embodiment, the cathode 80 and anode 76 comprise porous electrodes that are made of carbon plates treated with a catalyst (e.g., platinum or another noble metal). The polymer electrolyte membrane 78 may comprise a solid polymer, potassium hydroxide within a polymer matrix, or another suitable composition.

The fuel cell stack 54 may use hydrogen as fuel and oxygen or compressed air. At the anode 76, the hydrogen combines with hydroxide ions to produce water vapor and an outward flow of electrons from the anode 76. At the cathode 80, the cathode 80 receives electrons from the anode 76; oxygen and water form hydroxide ions which are made available to the anode 76.

The heat exchanger 48 is in fluidic communication with liquid cooling channels associated with the fuel cell stack 54 to keep the fuel cell stack 54 operating at an appropriate temperature. A PEM fuel cell may operate at a temperature greater than 800C. The catalyst and the air compression (e.g., 2 to 3 atmospheres) facilitates increased chemical reaction within the fuel cell stack 54.

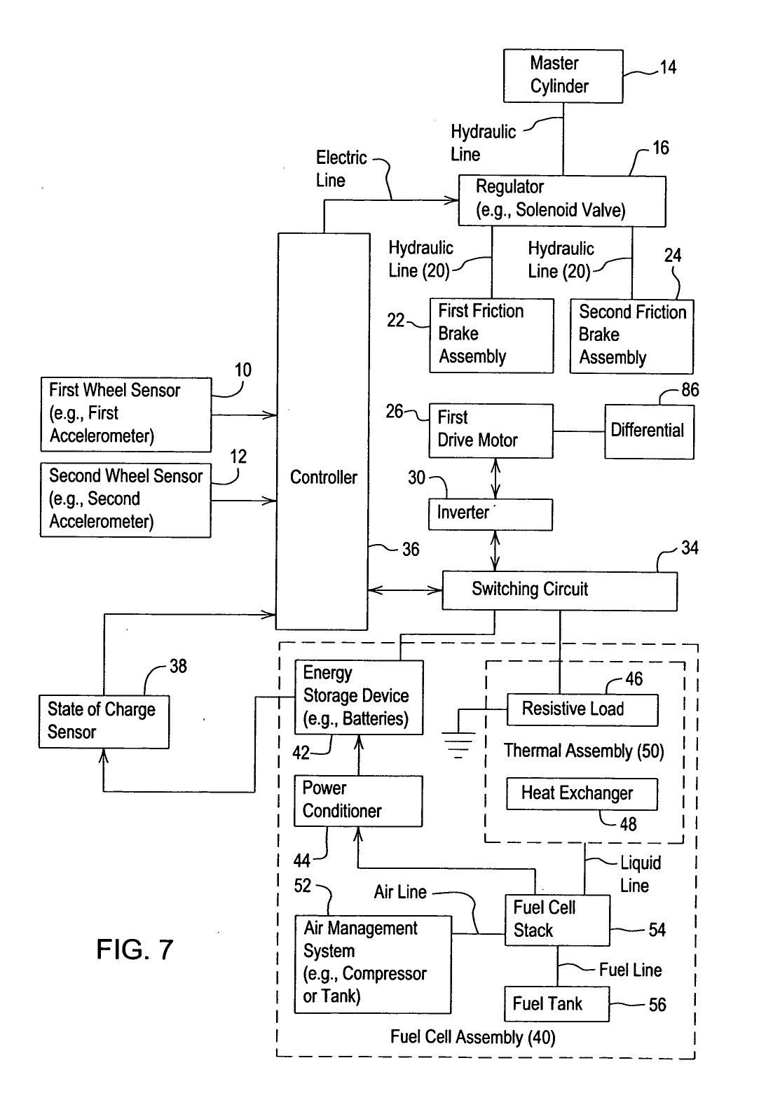

The vehicular system of FIG. 7 is similar to the system of FIG. 1, except the vehicular system of FIG. 7 deletes the second drive motor 28 of FIG. 1 and includes a differential 86. The vehicular system of FIG. 7 includes only a single traction motor designated as the first drive motor 26, but other configurations are possible and fall within the scope of the invention. The first drive motor 26 is coupled to the differential 86 such that the first drive motor 26 can apply torque or rotational force to two or more wheels (or the equivalent rotating members of a tracked vehicle).

The vehicular system of FIG. 8 is similar to the system of FIG. 1 except the energy storage device 42 of FIG. 1 is replaced with the ultracapacitor module 142 and the resistive load 46 may be connected in series to the ultracapacitor module 142, for example. The energy storage device 42 of FIG. 1 does not exclude an ultracapacitor within its definition, however. The series connection of the resistive load 46 of FIG. 8 facilitates using the resistive load 46 to limit the current applied to the ultracapacitor module 142 to avoid damage from electrical transients during start-up mode of the fuel cell stack 54, or otherwise. The fuel cell assembly 140 of FIG. 8 includes the ultracapacitor module 142, which may comprise an array of capacitors connected in parallel, or otherwise, to achieve a large aggregate capacitance.

In accordance with the invention, the same liquid cooling system is used by both the fuel cell stack 54 and the resistive load 46. The heat generated by the resistive load 46 supports the fuel cell stack 54 in at least two ways. First, operating the resistive load 46 during stack warm-up mode reduces the duration or extent of the power-limited warm-up mode of the fuel cell stack 54. The fuel cell stack 54 does not operate efficiently until it reaches a certain minimum operating temperature. Second, the resistive load 46 provides freeze protection to the fuel cell stack 54 during cold-weather transport and storage, which otherwise could irreversibly damage the fuel cell components. For example, by using the regenerative braking mode as a triggering event, the vehicle controller 36 could regulate the state of the energy storage device 42 by providing predictive and feedback-based control techniques, including optimal and/or adaptive control strategies.

In one illustrative embodiment, where the work vehicle comprises a mower (e.g., a greens mower), the resistive load 46 may dissipate approximately 5 kW of thermal energy for absorption by the heat exchanger 48 (e.g., radiator) or fuel cell stack 54. Further, the mower may replace the hydraulic braking system (including the master cylinder 14, the regulator 16, and the friction brake assemblies 22, 24) with an manual braking system (e.g., a nonhydraulic or cable-operated friction braking configuration).

Having described the preferred embodiment, it will become apparent that various modifications can be made without departing from the scope of the invention as defined in the accompanying claims.

The following is claimed:

1. A method for controlling a vehicle having a regenerative braking unit, the method comprising:
detecting a starting time of a fuel cell stack associated with a vehicle;
generating electrical energy during braking or deceleration of the vehicle via an electric drive motor mechanically coupled to at least one wheel of the vehicle;
determining a time window following the starting time;
routing the electrical energy to a resistive load associated with a heat exchanger thermally coupled to a fuel cell stack of the vehicle if the electrical energy is generated during the time window.

2. The method according to claim 1 further comprising:
routing the electrical energy to an energy storage device of the vehicle if the electrical energy is generated after the time window.

3. The method according to claim 1 further comprising:
positioning the resistive load in a vehicle cooling loop between a cooling exit of the fuel cell stack and an entrance of the heat exchanger.

4. The method according to claim 1 further comprising:
applying friction braking to the at least one wheel of vehicle to supplement the electromechanical braking effect of the electric drive motor.

5. The method according to claim 1 further comprising routing the electrical energy to an energy storage device of the vehicle if the electrical energy is generated after the time window and if the state of charge indicates a less than fully charged state of the energy storage device.

6. The method according to claim 1 wherein the routing comprises operating a switching circuit to switch electrical energy generated to the resistive load.

7. The method according to claim 1 further comprising:
controlling a flow of hydraulic fluid to friction brake assemblies based on one or more accelerometers associated with the at least one wheel.

8. A method for controlling a vehicle having a regenerative braking unit, the method comprising:
detecting a starting time of a fuel cell stack associated with a vehicle;
generating electrical energy during braking or deceleration of the vehicle;
determining a time window following the starting time;
routing the electrical energy to an energy storage device via a resistive load if the electrical energy is generated during the time window.

9. The method according to claim 8 wherein the energy storage device comprises an ultracapacitor storage module.

10. The method according to claim 8 further comprising:
routing the electrical energy to an energy storage device of the vehicle if the electrical energy is generated after the time window.

11. The method according to claim 8 further comprising:
positioning the resistive load in a vehicle cooling loop between a cooling exit of the fuel cell stack and an entrance of the heat exchanger.

12. The method according to claim 8 further comprising:
applying friction braking to the at least one wheel of vehicle to supplement the electromechanical braking effect of the electric drive motor.

13. The method according to claim 8 further comprising routing the electrical energy to an energy storage device of the vehicle if the electrical energy is generated after the time window and if the state of charge indicates a less than fully charged state of the energy storage device.

14. The method according to claim 8 wherein the routing comprises operating a switching circuit to switch electrical energy generated to the resistive load.

15. The method according to claim 8 further comprising:
controlling a flow of hydraulic fluid to friction brake assemblies based on one or more accelerometers associated with the at least one wheel.

16. A system for controlling a vehicle having a regenerative braking unit, the system comprising:
a heat exchanger for transferring thermal energy associated with a fuel cell stack of a vehicle;
a resistive load in thermal communication with at least one of the fuel cell stack and the heat exchanger;
a controller for detecting a starting time of a fuel cell stack associated with a vehicle and for determining a time window following the starting time;
a drive motor for generating electrical energy during braking or deceleration of the vehicle via an electric drive motor mechanically coupled to at least one wheel of the vehicle; and
a switching circuit for routing the electrical energy to the resistive load if the electrical energy is generated during the time window.

17. The system according to claim 16 wherein the switching circuit routes the electrical energy to an energy storage device of the vehicle if the electrical energy is generated after the time window.

18. The system according to claim 16 wherein the resistive load is located in a vehicle cooling loop between a cooling exit of the fuel cell stack and an entrance of the heat exchanger.

19. The system according to claim 16 further comprising:
a friction brake associated with a corresponding wheel of the vehicle;
a regulator for applying friction braking to the corresponding wheel of vehicle to supplement the electromechanical braking effect of the electric drive motor.

20. The system according to claim 16 wherein the switching circuit routes the electrical energy to an energy storage device of the vehicle if the electrical energy is generated after the time window and if the state of charge indicates a less than fully charged state of the energy storage device.

21. The system according to claim 16 wherein the switching circuit comprises switches electrical energy generated to the resistive load.

22. The system according to claim 16 further comprising:
an accelerometer associated with a corresponding wheel of the vehicle;
a friction brake assembly associated with the corresponding wheel;
a regulator for controlling a flow of hydraulic fluid to the friction brake assembly based on a signal output or data output of the accelerometer.
